(19) United States
(12) Patent Application Publication
(10) Pub. No.: US 2023/0351257 A1
(43) Pub. Date: Nov. 2, 2023

(54) METHOD AND SYSTEM FOR TRAINING VIRTUAL AGENTS THROUGH FALLBACK ANALYSIS

(71) Applicants: Akash Mourya; Anuja Anil Kumar Singh; Ashwini Patil; Asif Hasan; Gaurav Johar; Harshit Shah; Himanshu Kumar; Kanishk Mehta; Saravanan Murugan; Sreevasthavan K C; Surya S G; Tridib Paul

(72) Inventors: Akash Mourya; Anuja Anil Kumar Singh; Ashwini Patil; Asif Hasan; Gaurav Johar; Harshit Shah; Himanshu Kumar; Kanishk Mehta; Saravanan Murugan; Sreevasthavan K C; Surya S G; Tridib Paul

(21) Appl. No.: 18/218,059

(22) Filed: Jul. 4, 2023

(51) Int. Cl. G06N 20/00

(52) U.S. Cl. CPC G06N 20/00

(57) ABSTRACT

A method and system for training a virtual agent through fallback analysis is provided herein. The method comprises obtaining a plurality of fallback utterances. The method further comprises classifying the plurality of fallback utterances into one or more of existing intent categories, via a Machine Learning (ML) model. The method further comprises upon unsuccessful classification of one or more utterances of the plurality of fallback utterances, clustering the one or more utterances into one or more groups based on similarities among the one or more utterances, via the ML model. Further, the method comprises generating labels for the one or more groups to determine names of new intent categories associated with the one or more utterances.

### TECHNICAL FIELD OF THE INVENTION

The present disclosure is related to method and system for training virtual agents through fallback analysis. More specifically, the disclosure relates to leveraging fallback logs to suggest new training phrases for existing intents and recommend new intents based on clusters of fallback utterances.

### BACKGROUND OF THE INVENTION

A virtual agent refers to an interactive software program or system that simulates human-like conversations or interactions using artificial intelligence (AI) techniques. The virtual agent is designed to communicate with users in a natural language format, typically through text-based chat interfaces or voice-based interactions. The virtual agent is capable of understanding user queries or requests, interpreting the context, and providing appropriate responses or actions.

The virtual agent's functionality is based on advanced algorithms and AI models, which enables processing and analyzing user input, extracting relevant information, and generating meaningful and contextually appropriate responses. The virtual agent may utilize various techniques such as natural language processing (NLP), machine learning, pattern recognition, and knowledge representation to achieve accurate understanding and effective communication with users.

The virtual agent's capabilities may include but are not limited to:
Natural Language Understanding (NLU): The virtual agent is equipped with NLU algorithms to comprehend user intents, extract key information, and identify the context of the conversation.
Contextual Understanding: The virtual agent is capable of maintaining contextual awareness throughout the conversation, ensuring that responses are relevant and coherent within the ongoing dialogue.
Dialogue Management: The virtual agent utilizes sophisticated dialogue management techniques to maintain a coherent and engaging conversation flow, handling multiple turns and managing user expectations.
Knowledge Base Integration: The virtual agent can access and integrate with a knowledge base or database containing relevant information to provide accurate and up-to-date responses to user inquiries.
Personalization: The virtual agent may employ user profiling techniques to tailor responses based on individual preferences, past interactions, or demographic information.
Task Execution: The virtual agent may perform various tasks or actions on behalf of the user, such as retrieving information from external sources, making reservations, or initiating specific processes.
Training a virtual agent is highly significant because it allows the agent to acquire the necessary knowledge, skills, and understanding to effectively interact with users. Through training, the virtual agent gains the ability to comprehend user input, interpret the context accurately, and generate appropriate responses or actions.

One of the challenges in developing virtual agents is training them to accurately understand user inputs and respond appropriately. Traditional approaches involve manually identifying new intents (the purpose or goal behind a user's input) and creating training phrases for these intents. However, this manual process is time-consuming, error-prone, and may result in poor intent training, leading to inaccurate or unsatisfactory responses.

There is, therefore, a need in the present state of art, for an automated method and system that leverages a fallback analysis to suggest new training phrases and intent recommendations using the logs of fallback utterances. By automating this process, developers may save considerable time and effort that would otherwise be spent in manually identifying new intents and possible training phrases.

It is within this context that the present embodiments arise.

### SUMMARY

The following embodiments present a simplified summary in order to provide a basic understanding of some aspects of the disclosed invention. This summary is not an extensive overview, and it is not intended to identify key/critical elements or to delineate the scope thereof. Its sole purpose is to present some concepts in a simplified form as a prelude to the more detailed description that is presented later.

Some example embodiments disclosed herein provide a method for training a virtual agent through fallback analysis, the method comprising obtaining a plurality of fallback utterances. The method may further include classifying the plurality of fallback utterances into one or more of existing intent categories, via a Machine Learning (ML) model. The method may further include upon unsuccessful classification of one or more utterances of the plurality of fallback utterances, clustering the one or more utterances into one or more groups based on similarities among the one or more utterances, via the ML model. The method may also include generating labels for the one or more groups to determine names of new intent categories associated with the one or more utterances.

According to some example embodiments, the method further comprising training the virtual agent based on the one or more groups of the one or more utterances, wherein the one or more utterances comprises training phrases.

According to some example embodiments, fallback logs comprise the plurality of fallback utterances.

According to some example embodiments, the plurality of fallback utterances corresponds to at least one of incorrect responses, ambiguous responses, or insufficient responses generated by the virtual agent for queries.

According to some example embodiments, the method further comprising receiving a query from a user; generating a response for the query, wherein the response is one of an incorrect response, an ambiguous response, or an insufficient response; storing the query in the fallback logs; and mining the logs to obtain the plurality of utterances.

According to some example embodiments, the ML model is a classification model.

According to some example embodiments, the classification model comprises at least one of a logistic regression model, a decision tree, a random forest model, a Support Vector Machine (SVM), or an automated machine learning (AutoML) model.

According to some example embodiments, the ML model is a clustering model.

According to some example embodiments, the clustering model uses at least one of a K-means clustering algorithm, a hierarchical clustering algorithm, a density-based spatial clustering algorithm, a gaussian mixture model, or hybrid ensemble models.

According to some example embodiments, generating the labels comprises assigning generic names to the one or more groups.

Some example embodiments disclosed herein provide a computer system for training a virtual agent through fallback analysis, the computer system comprises one or more computer processors, one or more computer readable memories, one or more computer readable storage devices, and program instructions stored on the one or more computer readable storage devices for execution by the one or more computer processors via the one or more computer readable memories, the program instructions comprising obtaining a plurality of fallback utterances. The one or more processors are further configured for classifying the plurality of fallback utterances into one or more of existing intent categories, via a Machine Learning (ML) model. The one or more processors are further configured for upon unsuccessful classification of one or more utterances of the plurality of fallback utterances. The one or more processors are further configured for clustering the one or more utterances into one or more groups based on similarities among the one or more utterances, via the ML model. The one or more processors are further configured for generating labels for the one or more groups to determine names of new intent categories associated with the one or more utterances.

Some example embodiments disclosed herein provide a non-transitory computer readable medium having stored thereon computer executable instruction which when executed by one or more processors, cause the one or more processors to carry out operations for training a virtual agent through fallback analysis. The operations comprising obtaining a plurality of fallback utterances. The operations further comprising classifying the plurality of fallback utterances into one or more of existing intent categories, via a Machine Learning (ML) model. The operations further comprising upon unsuccessful classification of one or more utterances of the plurality of fallback utterances, clustering the one or more utterances into one or more groups based on similarities among the one or more utterances, via the ML model. The operations further comprising generating labels for the one or more groups to determine names of new intent categories associated with the one or more utterances.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF DRAWINGS

The above and still further example embodiments of the present disclosure will become apparent upon consideration of the following detailed description of embodiments thereof, especially when taken in conjunction with the accompanying drawings, and wherein:

FIG. 1 illustrates a use case of a user interaction with a virtual agent, in accordance with an example embodiment;

FIG. 2 illustrates a block diagram of an electronic circuitry for generating a response through a virtual agent, in accordance with an example embodiment;

FIG. 3 shows a flow diagram of a user interaction with a virtual agent, in accordance with an example embodiment;

FIG. 4 illustrates a block diagram for generating a response through a virtual agent, in accordance with an example embodiment;

FIG. 5 shows a flow diagram of a method for training a virtual agent through fallback analysis, in accordance with an example embodiment;

FIG. 6 illustrates a flow diagram for obtaining a plurality of fallback utterances from fallback logs in accordance with an example embodiment;

FIG. 7 shows a flow diagram of a method for generating labels for new intent, in accordance with an example embodiment;

FIG. 8 shows a flow diagram of a method for generating a response based on training a virtual agent, in accordance with an example embodiment;

FIG. 9 illustrates an exemplary GUI depicting a classified utterances view, in accordance with an example embodiment; and

FIG. 10 illustrates an exemplary GUI depicting a newly identified utterances view, in accordance with an example embodiment.

The figures illustrate embodiments of the invention for purposes of illustration only. One skilled in the art will readily recognize from the following description that alternative embodiments of the structures and methods illustrated herein may be employed without departing from the principles of the invention described herein.

### DETAILED DESCRIPTION

In the following description, for purposes of explanation, numerous specific details are set forth in order to provide a thorough understanding of the present disclosure. It will be apparent, however, to one skilled in the art that the present disclosure can be practiced without these specific details. In other instances, systems, apparatuses, and methods are shown in block diagram form only in order to avoid obscuring the present invention.

Reference in this specification to “one embodiment” or “an embodiment” or “example embodiment” means that a particular feature, structure, or characteristic described in connection with the embodiment is included in at least one embodiment of the present invention. The appearance of the phrase “in one embodiment” in various places in the specification are not necessarily all referring to the same embodiment, nor are separate or alternative embodiments mutually exclusive of other embodiments. Further, the terms “a” and “an” herein do not denote a limitation of quantity, but rather denote the presence of at least one of the referenced items. Moreover, various features are described which may be exhibited by some embodiments and not by others. Similarly, various requirements are described which may be requirements for some embodiments but not for other embodiments.

Some embodiments of the present disclosure will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout.

The terms “comprise”, “comprising”, “includes”, or any other variations thereof, are intended to cover a non-exclusive inclusion, such that a setup, device, or method that comprises a list of components or steps does not include only those components or steps but may include other components or steps not expressly listed or inherent to such setup or device or method. In other words, one or more elements in a system or apparatus proceeded by “comprises . . . a” does not, without more constraints, preclude the existence of other elements or additional elements in the system or method.

Furthermore, one or more computer-readable storage media may be utilized in implementing embodiments consistent with the present invention. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., are non-transitory. Examples include random access memory (RAM), read-only memory (ROM), volatile memory, non-volatile memory, hard drives, CD ROMs, DVDs, flash drives, disks, and any other known physical storage media.

The embodiments are described herein for illustrative purposes and are subject to many variations. It is understood that various omissions and substitutions of equivalents are contemplated as circumstances may suggest or render expedient but are intended to cover the application or implementation without departing from the spirit or the scope of the present invention. Further, it is to be understood that the phraseology and terminology employed herein are for the purpose of the description and should not be regarded as limiting. Any heading utilized within this description is for convenience only and has no legal or limiting effect.

### Definitions

The term “module” used herein may refer to a hardware processor including a Central Processing Unit (CPU), an Application-Specific Integrated Circuit (ASIC), an Application-Specific Instruction-Set Processor (ASIP), a Graphics Processing Unit (GPU), a Physics Processing Unit (PPU), a Digital Signal Processor (DSP), a Field Programmable Gate Array (FPGA), a Programmable Logic Device (PLD), a Controller, a Microcontroller unit, a Processor, a Microprocessor, an ARM, or the like, or any combination thereof.

The term “machine learning model” may be used to refer to a computational or statistical or mathematical model that is trained on classical ML modelling techniques with or without classical image processing. The “machine learning model” is trained over a set of data and using an algorithm that it may use to learn from the dataset.

The term “artificial intelligence” may be used to refer to a model built using simple or complex Neural Networks using deep learning techniques and computer vision algorithms. Artificial intelligence model learns from the data and applies that learning to achieve specific pre-defined objectives.

The term “virtual agent” may be used to refer to a virtual assistant that is computer program or AI system designed to simulate human-like conversations with users. They are typically powered by artificial intelligence and natural language processing technologies. The virtual agent can understand user inputs, generate appropriate responses, and perform specific tasks or provide information. They are often used in customer support, information retrieval, and other applications to provide automated and efficient conversational experiences.

### End of Definitions

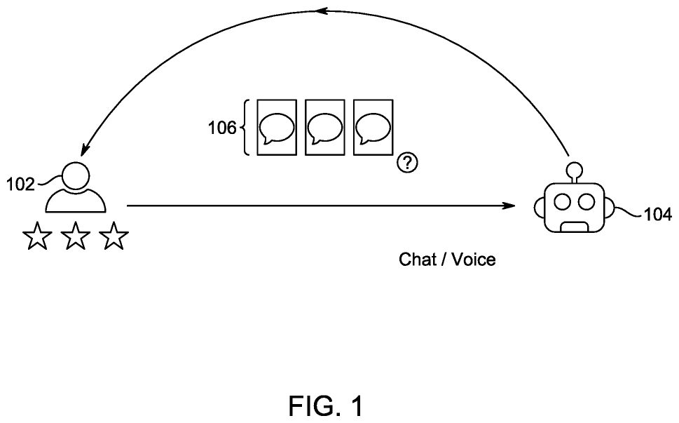

Embodiments of the present disclosure may provide a method, a system, and a computer program product for training a virtual agent. The method, the system, and the computer program product for training a virtual agent are described with reference to FIG. 1 to FIG. 10 as detailed below.

FIG. 1 illustrates a use case 100 of a user 102 interaction with a virtual agent 104, in accordance with an example embodiment. In an embodiment. The interaction begins when the user 102 provides input to the virtual agent 104 through a medium 106. The medium 106 for communication between the user 110 and the human agent 112 may be either in a form of voice or text. The user 102 may be, for example, a customer, client, or any other person seeking information or assistance through the virtual agent 104.

The user input may represent a query, request, or command from the user 102, indicating their intention or information they seek. The user input serves as the starting point for the virtual agent 104 to understand the user's needs and provide appropriate assistance or information. It ranges from specific questions or requests to more general inquiries or tasks. The objective of the virtual agent 104 is to accurately interpret and process the user input to deliver a relevant and helpful response.

The virtual agent 104 may be capable of creating a smooth and seamless user experience by effectively capturing and interpreting the user's intent, regardless of the input format or language used. By understanding the user's intent accurately, the virtual agent 104 may provide more relevant and tailored responses, improving the overall user satisfaction and achieving the goals of the interaction.

However, there are circumstances where the virtual agent 104 is unable to process the query of the user 102, or may provide incorrect, ambiguous, or insufficient responses to the user 102. In such cases the virtual agent needs to be trained to ensure accurate and adequate responses to user queries.

Here are some common examples where such condition may occur:

New or uncommon user queries: When user ask questions or provide inputs that fall outside the predefined training data of the virtual agent, it may struggle to understand and respond appropriately.

Lexical variations and language nuances: Different users may express the same intent using varied phrasing, slang, or regional language nuances, which the virtual agent may not be equipped to handle without further training.

Evolving user needs and context: As user needs and contexts evolve over time, the virtual agent may encounter queries that were not anticipated during its initial training, leading to inaccurate or inadequate responses.

Complex or ambiguous queries: Users may pose complex or ambiguous queries that require deeper understanding or disambiguation. Without proper training, the virtual agent may struggle to provide satisfactory responses in such scenarios.

Intent confusion and intent clashing: If the virtual agent have not been trained to differentiate between similar intents or handle potential conflicts between intents, it may provide incorrect or conflicting responses to user queries.

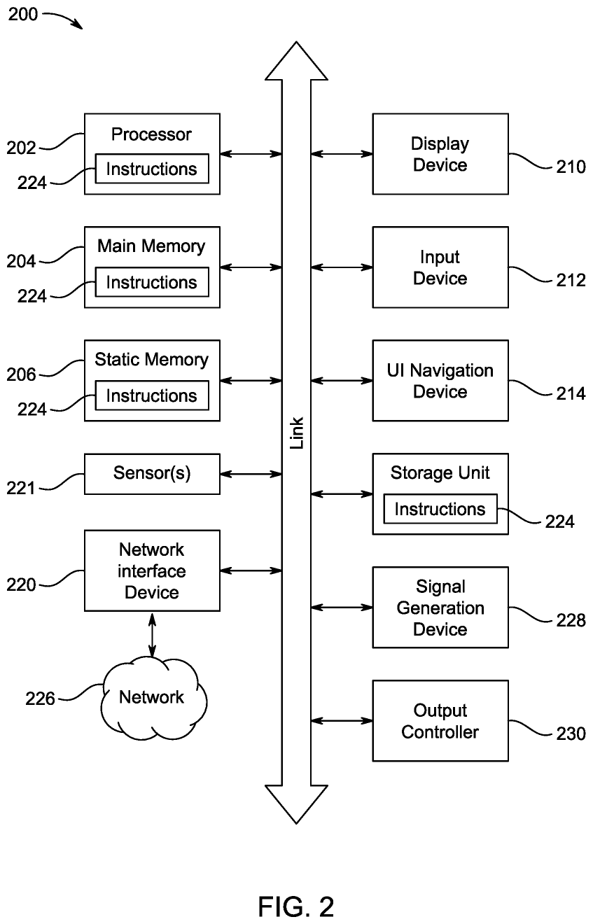

In all such cases by training through a fallback analysis, the virtual agent can identify and learn from these new intents, enabling it to provide accurate and adequate responses to user queries. This is further explained in greater detail in conjunction with FIGS. 2-10.

FIG. 2 illustrates a block diagram of an electronic circuitry for training a virtual agent through fallback analysis. The machine of FIG. 2 is shown as a standalone device, which is suitable for implementation of the concepts above. For the server aspects described above a plurality of such machines operating in a data center, part of a cloud architecture, and so forth can be used. In server aspects, not all of the illustrated functions and devices are utilized. For example, while a system, device, etc. that a user uses to interact with a server and/or the cloud architectures may have a screen, a touch screen input, etc., servers often do not have screens, touch screens, cameras and so forth and typically interact with users through connected systems that have appropriate input and output aspects. Therefore, the architecture below should be taken as encompassing multiple types of devices and machines and various aspects may or may not exist in any particular device or machine depending on its form factor and purpose (for example, servers rarely have cameras, while wearables rarely comprise magnetic disks). However, the example explanation of FIG. 2 is suitable to allow those of skill in the art to determine how to implement the embodiments previously described with an appropriate combination of hardware and software, with appropriate modification to the illustrated embodiment to the particular device, machine, etc. used.

While only a single machine is illustrated, the term “machine” shall also be taken to include any collection of machines that individually or jointly execute a set (or multiple sets) of instructions to perform any one or more of the methodologies discussed herein.

The example of the machine 200 includes at least one processor 202 (e.g., a central processing unit (CPU), a graphics processing unit (GPU), advanced processing unit (APU), or combinations thereof), one or more memories such as a main memory 204, a static memory 206, or other types of memory, which communicate with each other via link 208. Link 208 may be a bus or other type of connection channel. The machine 200 may include further optional aspects such as a graphics display unit 210 comprising any type of display. The machine 200 may also include other optional aspects such as an alphanumeric input device 212 (e.g., a keyboard, touch screen, and so forth), a user interface (UI) navigation device 214 (e.g., a mouse, trackball, touch device, and so forth), a storage unit 216 (e.g., disk drive or other storage device(s)), a signal generation device 218 (e.g., a speaker), sensor(s) 221 (e.g., global positioning sensor, accelerometer(s), microphone(s), camera(s), and so forth), output controller 228 (e.g., wired or wireless connection to connect and/or communicate with one or more other devices such as a universal serial bus (USB), near field communication (NFC), infrared (IR), serial/parallel bus, etc.), and a network interface device 220 (e.g., wired and/or wireless) to connect to and/or communicate over one or more networks 226.

Executable Instructions and Machine-Storage Medium

The various memories (i.e., 204, 206, and/or memory of the processor(s) 202) and/or storage unit 216 may store one or more sets of instructions and data structures (e.g., software) 224 embodying or utilized by any one or more of the methodologies or functions described herein. These instructions, when executed by processor(s) 202 cause various operations to implement the disclosed embodiments.

### Example Machine Architecture and Machine-Readable Medium

FIG. 2 illustrates a representative machine architecture suitable for implementing the systems and so forth or for executing the methods disclosed herein. The machine of FIG. 2 is shown as a standalone device, which is suitable for implementation of the concepts above. For the server aspects described above a plurality of such machines operating in a data center, part of a cloud architecture, and so forth can be used. In server aspects, not all of the illustrated functions and devices are utilized. For example, while a system, device, etc. that a user uses to interact with a server and/or the cloud architectures may have a screen, a touch screen input, etc., servers often do not have screens, touch screens, cameras and so forth and typically interact with users through connected systems that have appropriate input and output aspects. Therefore, the architecture below should be taken as encompassing multiple types of devices and machines and various aspects may or may not exist in any particular device or machine depending on its form factor and purpose (for example, servers rarely have cameras, while wearables rarely comprise magnetic disks). However, the example explanation of FIG. 2 is suitable to allow those of skill in the art to determine how to implement the embodiments previously described with an appropriate combination of hardware and software, with appropriate modification to the illustrated embodiment to the particular device, machine, etc. used.

While only a single machine is illustrated, the term “machine” shall also be taken to include any collection of machines that individually or jointly execute a set (or multiple sets) of instructions to perform any one or more of the methodologies discussed herein.

As used herein, the terms “machine-storage medium,” “device-storage medium,” “computer-storage medium” mean the same thing and may be used interchangeably in this disclosure. The terms refer to a single or multiple storage devices and/or media (e.g., a centralized or distributed database, and/or associated caches and servers) that store executable instructions and/or data. The terms shall accordingly be taken to include storage devices such as solid-state memories, and optical and magnetic media, including memory internal or external to processors. Specific examples of machine-storage media, computer-storage media and/or device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks. The terms machine-storage media, computer-storage media, and device-storage media specifically and unequivocally excludes carrier waves, modulated data signals, and other such transitory media, at least some of which are covered under the term “signal medium” discussed below.

Signal Medium

The term “signal medium” shall be taken to include any form of modulated data signal, carrier wave, and so forth. The term “modulated data signal” means a signal that has one or more of its characteristics set or changed in such a matter as to encode information in the signal.

Computer Readable Medium

The terms “machine-readable medium,” “computer-readable medium” and “device-readable medium” mean the same thing and may be used interchangeably in this disclosure. The terms are defined to include both machine-storage media and signal media. Thus, the terms include both storage devices/media and carrier waves/modulated data signals.

As used herein, the term “network” may refer to a long-term cellular network (such as GSM (Global System for Mobile Communication) network, LTE (Long-Term Evolution) network or a CDMA (Code Division Multiple Access) network) or a short-term network (such as Bluetooth network, Wi-Fi network, NFC (near-field communication) network, LoRaWAN, ZIGBEE or Wired networks (like LAN, el all) etc.).

As used herein, the term “computing device” may refer to a mobile phone, a personal digital assistance (PDA), a tablet, a laptop, a computer, VR Headset, Smart Glasses, projector, or any such capable device.

As used herein, the term ‘electronic circuitry’ may refer to (a) hardware-only circuit implementations (for example, implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

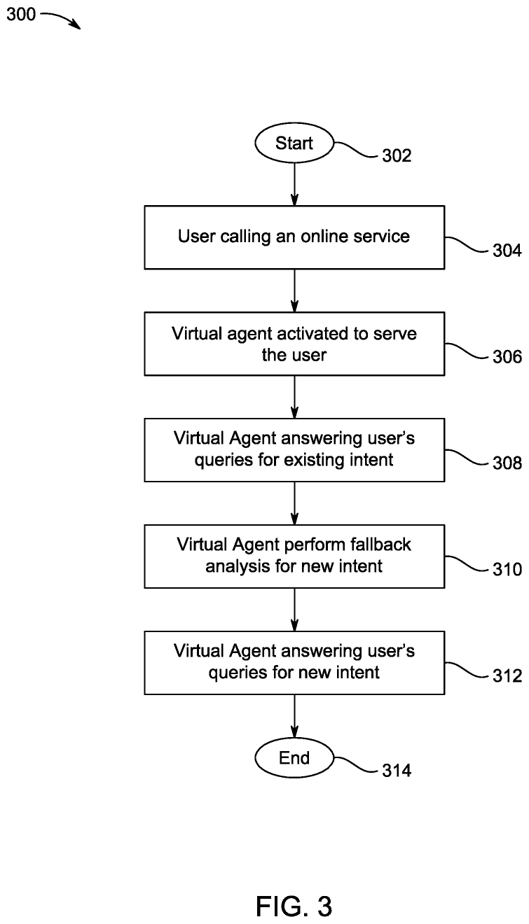

FIG. 3 shows a flow diagram of a user 102 interaction with a virtual agent 104. It will be understood that each block of the flow diagram of the method 300 may be implemented by various means, such as hardware, firmware, processor, circuitry, and/or other communication devices associated with execution of software including one or more computer program instructions 224. For example, one or more of the procedures described above may be embodied by computer program instructions 224. In this regard, the computer program instructions which embody the procedures described above may be stored by a memory 204 of the system 200, employing an embodiment of the present invention and executed by a processor 202. As will be appreciated, any such computer program instructions may be loaded onto a computer or other programmable apparatus (for example, hardware) to produce a machine, such that the resulting computer or other programmable apparatus implements the functions specified in the flow diagram blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flow diagram blocks.

Accordingly, blocks of the flow diagram support combinations of means for performing the specified functions and combinations of operations for performing the specified functions for performing the specified functions. It will also be understood that one or more blocks of the flow diagram, and combinations of blocks in the flow diagram, may be implemented by special purpose hardware-based computer systems which perform the specified functions, or combinations of special purpose hardware and computer instructions. The method 300 illustrated by the flowchart diagram of FIG. 3 shows the user interaction with the virtual agent. Fewer, more, or different steps may be provided.

The method 300 starts at step 302, and at the step 304 a user calls an online service. The user may initiate a call to the online service through various means such as, but not limited to, accessing a website, using a mobile application, or interacting with a chatbot.

In an embodiment, a virtual agent activated to serve the user at 306. In particular, the user who calls for the online service may seek assistance or information from the virtual agent. The virtual agent is an automated system that may be designed to interact with users and provide relevant information or assistance. The information may be related to order enquiry, billing enquiry, booking flights, finding accommodation, or getting recommendations for popular destinations and the like.

Further, at step 308 the virtual agent answers user's queries for existing intent. The virtual agent proceeds to answer the user's queries that fall within the scope of existing intents. These existing intents represent predefined categories or purposes behind user inputs that the virtual agent has been trained on. When a user's query matches one of these existing intents, the virtual agent utilizes its training to understand the intent and respond accordingly.

However, in situations where the user's query does not associate with any existing intents, then in that case the virtual agent performs fallback analysis to identify new intents, at step 310. Fallback refers to user utterances that the virtual agent is unable to understand or process effectively. The fallback analysis refers to a process of analyzing user queries or inputs that cannot be matched to any predefined intents or categories within a system. When a user submits a query that does not associate with existing intents, the virtual agent performs fallback analysis to understand the user's intent and generate an appropriate response.

In a more elaborative way, the virtual agent utilizes natural language understanding techniques to analyze and process the user's query. These techniques may involve tokenization, part-of-speech tagging, entity recognition, and other NLU processes to extract meaningful information from the query.

The virtual agent compares the processed user query with the existing intents in the system. This may be achieved using techniques such as pattern matching, keyword matching, or machine learning algorithms to find the best matching intent.

If the virtual agent does not find a suitable matching intent, it determines that the user's query does not associate with any existing intents. This triggers the fallback analysis process to identify new intents.

During the fallback analysis, the virtual agent may generate suggestions for new intents based on the characteristics of the user's query. These suggestions may be based on clustering similar queries, analyzing the intent patterns in the fallback utterances, or applying machine learning techniques to identify distinct user needs.

In some embodiments, user feedback may be incorporated into the fallback analysis process. Users may have the option to provide feedback on the virtual agent's response or indicate whether the provided intents match their query. This feedback may help to validate the need for new intents and refine the analysis process.

Upon identifying the new intent through fallback analysis, the virtual agent proceeds to answer user's queries for the new intent, at step 312 and the method 300 terminates at 314.

The method 300 can be better explained with the help of an example. Consider a scenario where the user is calling an online shopping service to inquire about product availability and place an order. The user might ask, “Is the blue shirt in stock?” or “How do I return a defective item?”. The virtual agent may accurately understand and respond to these queries based on its existing training data.

In some cases, the user may ask a question or make a request that the virtual agent is not adequately trained to handle. For instance, the user might ask, “Can I schedule a product demo with a sales representative?”. If the virtual agent is unsure how to respond, it enters a fallback state. During the fallback state, the virtual agent generates a fallback response, such as “I'm sorry, I didn't understand your request”. The user, in response to the fallback, might provide feedback utterances to express their frustration, confusion, or clarification needs. These feedback utterances may include statements like, “Your response doesn't make sense” or “I need to speak to a salesperson”.

The fallback utterances generated by the user are collected and analyzed. The fallback analysis process begins by classifying these utterances to determine if they are variations of existing intents. If they are variations, the virtual agent may suggest new training phrases for the corresponding intent, helping to improve its understanding and responses.

For the fallback utterances that cannot be classified into existing intents, the system applies clustering algorithms to group similar utterances together. Each cluster represents a possible new intent. In the above example, the feedback utterances expressing the need to speak to a salesperson may form a cluster, indicating a possible new intent related to sales assistance.

The virtual agent then runs intent name generation algorithms on the clusters to suggest relevant names or labels for the new intents. In this case, it might generate a suggested intent name like “Sales Inquiry” or “Sales Support”.

Once the new intent and its corresponding name are identified, the virtual agent may be trained on additional training phrases for the new intent to better understand and respond to similar user queries in the future. Thus, by analyzing the fallback utterances, generating new intents, and training phrases, the virtual agent becomes more adept at handling a broader range of user queries and can provide more accurate and helpful responses.

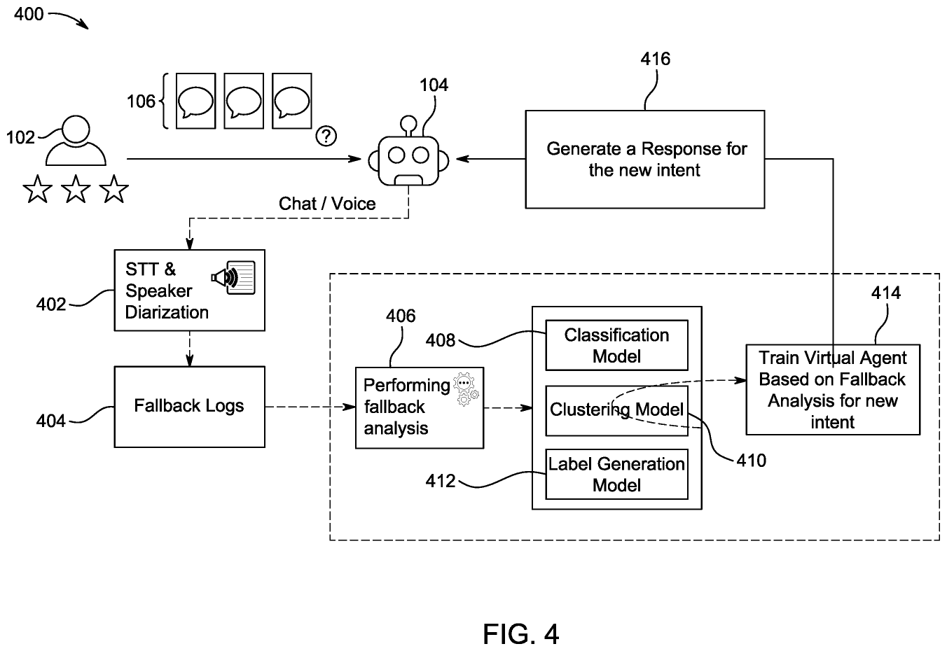

FIG. 4 illustrates a block diagram for training a virtual agent through fallback analysis, consistent with embodiments of the present disclosure. The user 102 interacts with a virtual agent 104 through a medium 106. In an embodiment the medium 106 may be text or voice. Furthermore, all the interactions are diarized and if required, a speech to text module 402 is used.

User messages contain the messages or queries sent by the user to the virtual agent. This can include text inputs, voice commands, or any other form of user communication.

Agent responses include the replies or responses generated by the virtual agent in reaction to the user's messages. These responses may be in the form of text, voice, or other relevant formats depending on the medium of interaction.

In an example embodiment, diarization of speaker refers to the process of identifying and distinguishing between different speakers in an audio conversation or interaction. Diarization involves segmenting the audio signal into distinct speaker turns or segments, labeling them according to the speaker's identity, and determining when a new speaker begins talking or when a speaker switch occurs.

Virtual agents or chatbots rely on natural language processing (NLP) to understand and respond to user inputs. However, in scenarios where multiple participants are involved, such as in group discussions or meetings, speaker diarization becomes essential to accurately attribute spoken content to specific individuals.

By performing speaker diarization, the virtual agent 104 may analyze the audio input, recognize different speakers, and associate their spoken content with respective identities. This enables the virtual agent 104 to provide more personalized and context-aware responses, tailor the interaction based on individual preferences or histories, and facilitate smoother multi-party conversations.

Speaker diarization algorithms typically utilize techniques such as voice activity detection (VAD) to determine when a speaker is active, speech segmentation to identify speaker boundaries, and speaker recognition or clustering algorithms to assign speakers to their respective segments. These algorithms can be trained on large amounts of audio data to improve their accuracy in distinguishing between different speakers and handling various acoustic environments.

Apart from the VAD, speaker change detection algorithms can also be employed to identify transitions between different speakers. These algorithms analyze acoustic features, such as pitch, energy, or spectral characteristics, to detect changes in the speaking style or characteristics, indicating a potential speaker change.

Further, advanced acoustic modeling techniques, such as Gaussian Mixture Models (GMMs) or Hidden Markov Models (HMMs), may be used to capture speaker-specific information and model the acoustic properties of individual speakers. These models may be trained on large datasets to learn speaker-specific patterns and improve the accuracy of diarization.

Alternatively, deep neural networks (DNNs) and deep learning architectures, such as recurrent neural networks (RNNs) or convolutional neural networks (CNNs), can also be applied to speaker diarization tasks. These models can learn complex patterns and representations of speaker characteristics, leading to improved accuracy in identifying speaker boundaries and assigning speakers to segments.

In addition to audio information, incorporating other modalities like video or textual data can enhance the diarization process. Visual cues from video, such as lip movements or facial expressions, can provide additional information for speaker identification. Textual data from transcriptions or subtitles can also be used to align speech segments with corresponding text and helps in diarization.

In an example embodiment, when the virtual agent encounters a user input that it cannot understand or respond to adequately within its existing intents then in that case a logged user input and corresponding fallback utterances are stored as part of fallback logs at block 404. The fallback logs act as a repository of fallback scenarios, capturing instances where the virtual agent encountered challenges in understanding user inputs or providing suitable responses. The fallback logs include the user's fallback utterances, timestamps, and other relevant information, which may be used for various purposes, such as analyzing user needs, identifying areas for system improvement, and generating new intents or training phrases.

The purpose of maintaining these fallback logs is to utilize the information for various purposes:

Analysis of User Needs: The fallback logs may be analyzed to get understanding of the types of queries or user needs that the virtual agent struggles to handle. By examining the patterns and commonalities in the fallback utterances, developers and system administrators may identify areas where the virtual agent requires improvement.

System Improvement: The fallback logs may be utilized to improve the virtual agent's performance and enhance its understanding of user inputs. By reviewing the logged fallback scenarios, developers may identify the root causes of fallbacks and make adjustments to the system, such as refining existing intents, adding new intents, or expanding the training data.

Generation of New Intents or Training Phrases: The logged fallback utterances may act as a valuable resource for generating new intents and training phrases. By clustering similar fallback utterances and applying intent name generation techniques, new intents may be identified and labeled. These new intents may then be used to train the virtual agent, improving its ability to understand and respond to similar user queries in the future.

Upon obtaining a plurality of fallback utterances from the fallback logs, a fallback analysis is performed to train the virtual agent for the new intents, at block 406. The fallback analysis may include steps of classification, clustering, and label generation.

In a more elaborative way, at block 408, the proposed system employs a machine learning classification model to classify fallback utterances as variations of existing intent training phrases. By comparing the patterns and semantic similarities between fallbacks and known training data, the system identifies which existing intents the fallback utterances belong to. This step ensures the utilization of existing training phrases and avoids duplication.

The classification may be performed by at least one of the following machine learning classification models: logistic regression, decision tree, random forest, Support Vector Machine (SVM), or an automated machine learning (AutoML) model. Here is how each of these models may be applied in the classification process:
Logistic Regression: Logistic regression is a statistical model used to estimate the probability of a binary outcome. In the context of fallback classification, a logistic regression model may be trained using existing intent training phrases as features and their corresponding intent labels as target variables. The model learns the relationship between the training phrases and intents, enabling it to predict the intent class for a given fallback utterance. By analyzing the probabilities assigned to each intent class, the model determines the closest matching existing intent for the fallback.
Decision Tree: A decision tree is a flowchart-like model where internal nodes represent features, branches represent decision rules, and leaf nodes represent the target labels. In the fallback classification process, a decision tree model may be built using existing intent training phrases as features and their corresponding intent labels as target variables. The model learns to partition the feature space based on the training data, allowing it to predict the intent class for a given fallback utterance by traversing the decision tree. Each decision node represents a specific criterion based on the features, leading to the identification of the closest matching existing intent.
Random Forest: A random forest model is an ensemble learning method that combines multiple decision trees to make predictions. In the context of fallback classification, a random forest may be trained using the existing intent training phrases as features and their corresponding intent labels as target variables. By aggregating the predictions from multiple decision trees, the random forest model provides a robust and accurate classification for a given fallback utterance. The model considers the collective decision of the individual trees to determine the closest matching existing intent.
Support Vector Machine (SVM): SVM is a supervised machine learning algorithm that may be used for classification tasks. In the fallback classification process, an SVM model may be trained using the existing intent training phrases as feature vectors and their corresponding intent labels as target variables. SVM aims to find a hyperplane that best separates the training data into different intent classes. By utilizing a kernel function, the SVM model may handle non-linear decision boundaries, allowing it to classify fallback utterances into the closest matching existing intent.
AutoML: AutoML model is an automated machine learning approach that aims to streamline the process of model selection, hyperparameter tuning, and training. In the fallback classification, the AutoML model takes the existing intent training phrases as input features and their corresponding intent labels as target variables. The model automatically explores and evaluates various classification algorithms, such as logistic regression, decision tree, random forest, and SVM, along with potential other models available within the AutoML framework.

By employing classification models such as logistic regression, decision tree, random forest, SVM, or AutoML, the system may perform the classification of fallback utterances into existing intent classes. It is to be noted that each model has its own capability to learns the patterns and relationships between training phrases and intent labels, enabling accurate prediction and identification of the most appropriate existing intent for a given fallback utterance.

Further, at block 410, for fallback utterances that cannot be classified into existing intents, the system applies machine learning clustering model (more preferably, machine learning clustering algorithms). These algorithms group similar fallback utterances into clusters, considering their semantic and contextual similarities. Each cluster represents a possible new intent, as the fallback utterances within the cluster share common characteristics.

The clustering may be performed by at least one of the following machine learning classification models: a K-means clustering algorithm, a hierarchical clustering algorithm, a density-based spatial clustering algorithm, a gaussian mixture model, or hybrid ensemble models. Here is how each of these models may be applied in the clustering process:
K-means clustering algorithm: The K-means algorithm is a popular clustering technique that partitions data into K clusters. It iteratively assigns data points to the nearest cluster centroid based on the Euclidean distance. By utilizing the K-means algorithm, the system may group fallback utterances into clusters, where each cluster represents a potential new intent.
Hierarchical clustering algorithm: The hierarchical clustering algorithm creates a hierarchical structure of clusters. It starts with each fallback utterance as an individual cluster and then merges the most similar clusters iteratively until a single cluster is formed. This hierarchical structure may be represented as a dendrogram. By using the hierarchical clustering algorithm, the system may identify clusters of fallback utterances based on their similarity levels.
Density-based spatial clustering algorithm: Density-based spatial clustering algorithms, such as DBSCAN (Density-Based Spatial Clustering of Applications with Noise), group data points based on their density and connectivity. It identifies dense regions of data points separated by sparse regions. By applying a density-based spatial clustering algorithm, the system may detect clusters of fallback utterances with varying densities and shapes, accommodating different patterns of user input.
Gaussian mixture model: A Gaussian mixture model (GMM) is a probabilistic model that assumes data points are generated from a mixture of Gaussian distributions. It assigns probabilities to each data point belonging to different clusters. By using a GMM, the system may capture complex patterns and uncertainty in the distribution of fallback utterances, identifying clusters based on the likelihood of each utterance belonging to a particular cluster.
Hybrid ensemble models: In the clustering fallback utterances, hybrid ensemble models combine the strengths of multiple clustering algorithms, such as the K-means clustering algorithm, hierarchical clustering algorithm, density-based spatial clustering algorithm, and Gaussian mixture model. These hybrid ensemble models aim to enhance the clustering performance and handle various data scenarios more effectively. The hybrid ensemble models employ a combination of clustering algorithms to overcome the limitations of individual algorithms and achieve more accurate and robust clustering results.

By employing these clustering models, the system provides a comprehensive and flexible approach to clustering fallback utterances. Each model offers unique strengths and capabilities, enabling the system to identify different types of clusters and effectively suggest new intents based on the grouped fallback utterances. It is to be noted that a selection of clustering models may be tailored to the specific requirements and characteristics of the fallback data to achieve accurate and meaningful clustering results.

Furthermore, at block 412, after clustering the remaining fallback utterances, the system employs label generation model (more preferably, intent name generation algorithms) to determine name of new intent. The intent name generation algorithms analyze the content and context of the clustered fallbacks to suggest relevant and descriptive names for the new intents. The generated intent names accurately reflect the underlying themes and concepts of the clustered fallback utterances. These algorithms consider various factors such as keyword analysis, semantic similarity, contextual cues, and linguistic patterns to generate relevant and appropriate names for the new intent categories.

The specific intent name generation algorithms used in the present invention may vary depending on the implementation. Several techniques and algorithms may be utilized for this purpose, including but not limited to:
Keyword Extraction: This algorithm identifies important keywords or phrases within the clustered fallback utterances. It analyzes the frequency, relevance, and significance of these keywords to generate intent names that capture the central theme of the utterances.
Semantic Analysis: This algorithm applies natural language processing techniques to understand the semantic relationships and similarities between the fallback utterances within each cluster. By considering the underlying meaning and context, it generates intent names that reflect the common intent or purpose shared by the utterances.
Language Modeling: This algorithm employs language models trained on large datasets to predict relevant intent names based on the linguistic patterns observed in the clustered fallback utterances. It leverages statistical analysis and pattern recognition to generate logical and meaningful intent labels.
Rule-based Approaches: This algorithm utilizes predefined rules or templates to generate intent names. These rules may be based on syntactic patterns, domain-specific knowledge, or linguistic rules. The system applies these rules to the clustered fallback utterances and generates intent names that adhere to the specified patterns.

It is to be noted that the specific algorithms used for intent name generation may be customized and adapted based on the requirements and characteristics of the virtual agent. The choice of algorithms depends on factors such as the complexity of the utterances, the desired level of specificity in intent naming, and the available training data.

After clustering the fallback utterances into groups representing possible new intents, at block 414, the virtual agent is trained based on these groups and their corresponding utterances. This step is to incorporate the clustered fallback utterances as new training data for the virtual agent's natural language understanding model.

With this expanded training data, the virtual agent's natural language understanding model is retrained. This may include updating the model's parameters, such as weights and biases, based on the combined training data. The training process typically utilizes machine learning algorithms, such as deep learning or statistical approaches, to optimize the model's performance in recognizing user intents accurately.

Once the virtual agent is trained by incorporating the newly identified intents and training phrases into the virtual agent's training data, it may now generate a response to a user's query, at block 416. This expanded training dataset enhances the virtual agent's understanding, enabling it to generate responses based on the training and provide accurate and contextually appropriate replies to user inputs.

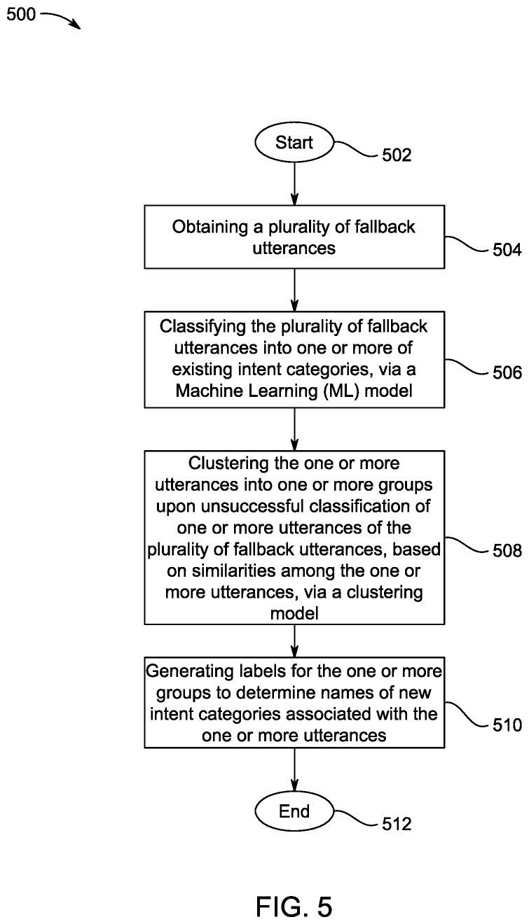

FIG. 5 illustrates a method 500 for training a virtual agent through fallback analysis, in accordance with an example embodiment. It will be understood that each block of the flow diagram of the method 500 may be implemented by various means, such as hardware, firmware, processor, circuitry, and/or other communication devices associated with execution of software including one or more computer program instructions. For example, one or more of the procedures described above may be embodied by computer program instructions. In this regard, the computer program instructions which embody the procedures described above may be stored by a memory 204 of the system 200, employing an embodiment of the present disclosure and executed by a processor 202. As will be appreciated, any such computer program instructions may be loaded onto a computer or other programmable apparatus (for example, hardware) to produce a machine, such that the resulting computer or other programmable apparatus implements the functions specified in the flow diagram blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flow diagram blocks.

Accordingly, blocks of the flow diagram support combinations of means for performing the specified functions and combinations of operations for performing the specified functions for performing the specified functions. It will also be understood that one or more blocks of the flow diagram, and combinations of blocks in the flow diagram, may be implemented by special purpose hardware-based computer systems which perform the specified functions, or combinations of special purpose hardware and computer instructions.

The method 500 illustrated by the flow diagram of FIG. 500 for training a virtual agent through fallback analysis start at 502. The method 500 may include, at step 504, obtaining a plurality of fallback utterances. The plurality of fallback utterances corresponds to at least one of incorrect responses, ambiguous responses, or insufficient responses generated by the virtual agent for queries.

Fallback utterances typically arise when the virtual agent generates incorrect, ambiguous, or insufficient responses for user queries. These fallback utterances represent user inputs of which the system was unable to understand or provide a satisfactory response. It indicates possible areas where the system's understanding or response generation may be improved.

By way of an example, if a user asks, “What is the weather like today?” and the virtual agent responds with an unrelated answer like, “I'm sorry, I don't have that information”, the user might provide a fallback utterance such as, “That's not what I asked for” or “You didn't answer my question”. These fallback utterances highlight instances where the virtual agent failed to provide the desired response.

The method 500, at step 506, may include classifying the plurality of fallback utterances into one or more of existing intent categories, via a Machine Learning (ML) model. The intent categories represent predefined labels or classes that capture different types of user intents for which the virtual agent is designed to understand and respond.

To perform the classification, a Machine Learning (ML) model is utilized. The ML model is trained on a dataset that includes examples of user inputs labeled with their corresponding intents. This training data helps the model to learn patterns and features that may distinguish one intent from another. The classification of fallback utterances using the ML model include training the model on a labeled dataset and then using it to predict the class or category of new, unlabeled data. Here are some general processes of classification using the ML model:
Dataset Preparation: First, a labeled dataset is created, consisting of examples where each instance is associated with a known class or category. In the context of the described method, this dataset would include user inputs labeled with their corresponding intents. The dataset is divided into a training set and a test set.
Feature Extraction: Features are extracted from the input data to represent the characteristics or attributes relevant to the classification task. These features can be linguistic, numerical, or derived from other forms of data representation. In the case of text-based classification, features might include word frequencies, n-grams, or semantic embeddings.
Model Training: The ML model, such as a classifier, is selected and trained using the labeled training dataset. During training, the model learns the underlying patterns and relationships between the input features and their corresponding labels. Various classification algorithms may be used, such as decision trees, support vector machines (SVM), logistic regression, or neural networks.
Model Evaluation: The trained model is evaluated using the test dataset to assess its performance and accuracy. Evaluation metrics such as accuracy, precision, recall, and F1 score are commonly used to measure the model's ability to correctly classify instances.
Prediction on New Data: Once the model is trained and evaluated, it may be used to predict the class or category of new, unlabeled data. The model takes in the extracted features from the new data and outputs the predicted class or a probability distribution across the possible classes.
Post-processing and Decision Threshold: Depending on the specific classification task, a decision threshold may be applied to convert the model's output probabilities into discrete class predictions. The threshold determines the confidence level required for an instance to be classified as a particular class.

It is to be noted that the specific ML model and algorithms used for classification may vary depending on the requirements, dataset characteristics, and available resources. The choice of model and feature extraction techniques should be tailored to the specific context and goals of the classification task.

The method 500, at step 508, may include, clustering the one or more utterances into one or more groups upon unsuccessful classification of one or more utterances of the plurality of fallback utterances, based on similarities among the one or more utterances, via a clustering model.
based on similarities among the one or more utterances, via the ML model. In other words, when one or more fallback utterances cannot be classified successfully into existing intent categories, the clustering is applied to group these utterances based on their similarities. The ML model learns the patterns and similarities among the utterances, helping to identify natural groupings or clusters. This allows for the creation of new training phrases and the suggestion of new intent categories based on the content of each cluster.

The general process for clustering using the ML model may include:
Dataset Preparation: The dataset consists of the fallback utterances that were not successfully classified into existing intent categories. These utterances are used as input for the clustering process. The dataset may also include features extracted from the utterances, such as word embeddings or other relevant representations.
Feature Extraction: Similar to classification, relevant features are extracted from the utterances to represent their characteristics. These features can capture semantic information, syntactic patterns, or any other attributes that can help measure the similarity between utterances.
ML Model Selection: An appropriate ML model for clustering is chosen based on the dataset and problem requirements. Commonly used clustering algorithms include K-means, hierarchical clustering, DBSCAN, or Gaussian mixture models. Each algorithm has its own assumptions and characteristics, which may be considered when selecting the most suitable model.
Model Training: The ML model is trained on the dataset, learning to identify patterns and similarities among the utterances. The training process aims to optimize the model's internal parameters to minimize the distance or dissimilarity between data points within each cluster while maximizing the dissimilarity between different clusters.
Similarity Measurement: During training, the model calculates the similarity or dissimilarity between each pair of utterances based on the chosen features and clustering algorithm. The specific similarity measure depends on the algorithm used (e.g., Euclidean distance, cosine similarity).
Clustering Process: The trained model applies the clustering algorithm to the dataset, grouping the utterances into one or more clusters based on their similarities. Each cluster represents a group of utterances that are more similar to each other than to those in other clusters.
Cluster Evaluation: After clustering, various metrics may be used to evaluate the quality of the resulting clusters, such as silhouette score or cluster purity. These metrics measure the consistency and separation of the clusters.
Post-processing and Interpretation: Once the clustering is complete, post-processing steps may be performed, such as assigning labels or representative names to the clusters based on their contents. These labels may serve as suggestions for new intent categories or training phrases.

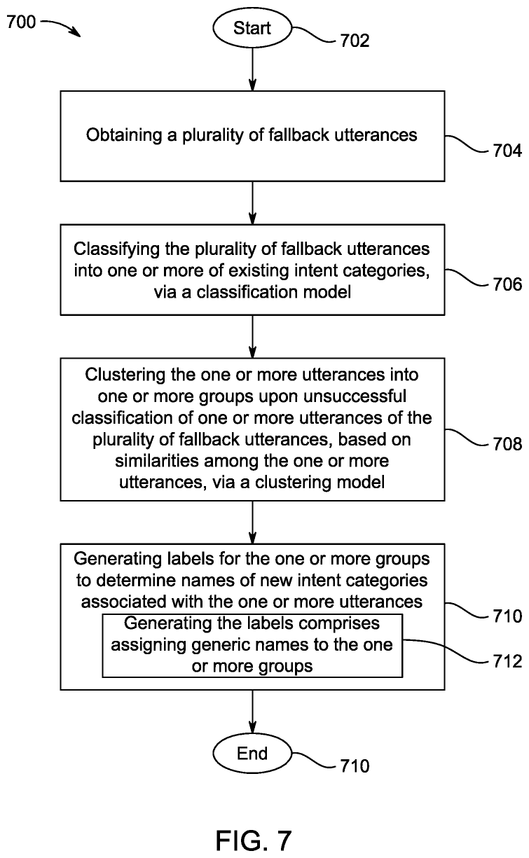

Further, the method 500, at step 510, may include generating labels for the one or more groups to determine names of new intent categories associated with the one or more utterances and the method 500 terminates at 512. The labels act as names or identifiers for the new intent categories associated with the utterances in each group. The labels should be descriptive and representative of the content or theme of the utterances within the cluster. A process of generating the labels is further explained in conjunction with FIG. 7. Here are some common approaches from which the label generation can be done:
Cluster Analysis: After the clustering process, there are one or more groups of fallback utterances that are considered similar based on the chosen features and clustering algorithm. Each group represents a distinct cluster of related utterances.
Analysis of Utterances in Each Cluster: The next step is to analyze the utterances within each cluster to understand their content and context. This analysis may involve examining the keywords, semantic patterns, or any other relevant information present in the utterances.
Language Processing Techniques: Natural Language Processing (NLP) techniques may be applied to extract meaningful information from the utterances within each cluster. This may involve techniques like named entity recognition, keyword extraction, part-of-speech tagging, or sentiment analysis to obtain interpretations into the content and purpose of the utterances.
Label Generation: Based on the analysis of the utterances within each cluster, labels or names are generated to represent the underlying intent or purpose of the utterances. These labels should capture the common theme or concept shared by the utterances within the cluster.
Labeling Criteria: The criteria for generating labels may vary depending on the specific context and requirements. It may include manually reviewing the utterances, identifying the most salient keywords or phrases, or utilizing automated techniques to generate descriptive labels.
Iterative Process: The label generation process may include an iterative approach, refining the labels based on feedback and further analysis. It's important to ensure that the generated labels accurately represent the intent or purpose of the utterances within each cluster.
Mapping Labels to Intent Categories: Finally, the generated labels are mapped to the corresponding new intent categories associated with the fallback utterances in each cluster. These labels provide meaningful names that may be used to identify and categorize the new intents within the system.

The objective of label generation process is to capture the essence of the utterances in each cluster and assign descriptive names that reflect the underlying intent or purpose. By generating these labels, the method 500 enables the identification and naming of new intent categories based on the content and context of the fallback utterances.

In some example embodiments, a computer programmable product may be provided. The computer programmable product may comprise at least one non-transitory computer-readable storage medium having stored thereon computer-executable program code instructions that when executed by a computer, cause the computer to execute the method 500.

In an example embodiment, an apparatus for performing the method 500 of FIG. 5 above may comprise a processor (e.g., the processor 202) configured to perform some or each of the operations of the method 500. The processor may, for example, be configured to perform the operations 502-512 by performing hardware implemented logical functions, executing stored instructions, or executing algorithms for performing each of the operations. Alternatively, the apparatus may comprise means for performing each of the operations described above. In this regard, according to an example embodiment, examples of means for performing operations (502-512) may comprise, for example, the processor 202 which may be implemented in the system 200 and/or a device or circuit for executing instructions or executing an algorithm for processing information as described above.

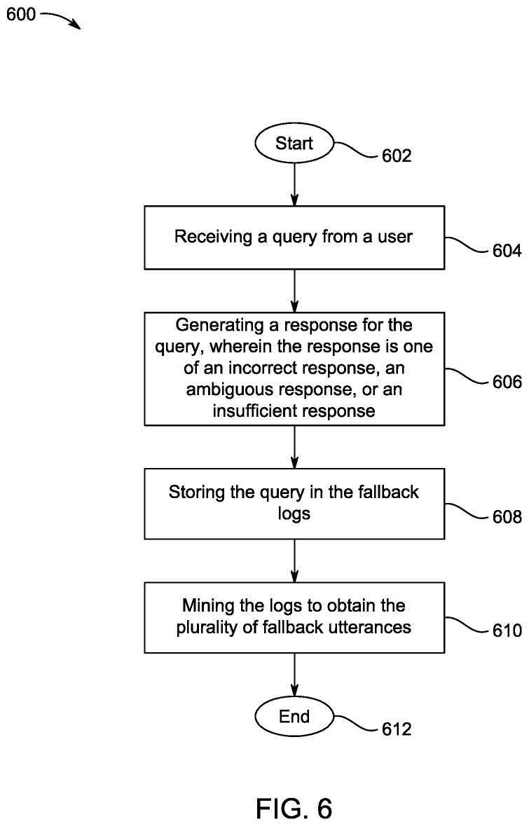

FIG. 6 shows a flow diagram of a method 600 for obtaining a plurality of fallback utterances from fallback logs, in accordance with an example embodiment. It will be understood that each block of the flow diagram of the method 600 may be implemented by various means, such as hardware, firmware, processor, circuitry, and/or other communication devices associated with execution of software including one or more computer program instructions 224. For example, one or more of the procedures described above may be embodied by computer program instructions 224. In this regard, the computer program instructions which embody the procedures described above may be stored by a memory 204 of the system 200, employing an embodiment of the present invention and executed by a processor 202. As will be appreciated, any such computer program instructions may be loaded onto a computer or other programmable apparatus (for example, hardware) to produce a machine, such that the resulting computer or other programmable apparatus implements the functions specified in the flow diagram blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flow diagram blocks.

Accordingly, blocks of the flow diagram support combinations of means for performing the specified functions and combinations of operations for performing the specified functions for performing the specified functions. It will also be understood that one or more blocks of the flow diagram, and combinations of blocks in the flow diagram, may be implemented by special purpose hardware-based computer systems which perform the specified functions, or combinations of special purpose hardware and computer instructions. The method 600 illustrated by the flowchart diagram of FIG. 6 shows a method for obtaining a plurality of fallback utterances from fallback logs. Fewer, more, or different steps may be provided.

The method 600 starting at 602 commences by receiving a query from a user in step 604 of method 600. This query represents the input or request made by the user to the virtual agent. It may be in the form of natural language text, voice input, or any other medium through which the user interacts with the virtual agent.

In an embodiment, the method 600, at step 606 may further include generating a response for the query. The response may be in the form of a text message, spoken words, or any other appropriate output format. The virtual agent attempts to provide a relevant and accurate response that addresses the user's query. The response generated in this step may fall into one of the following categories:
Incorrect Response: The virtual agent may generate a response that is incorrect or inaccurate in addressing the user's query.
Ambiguous Response: The response generated by the virtual agent may be ambiguous which does not provide a clear or definitive answer to the user's query.
Insufficient Response: The response provided by the virtual agent may be insufficient or incomplete in addressing the user's query, requiring further clarification or information.

Further, the method 600, at step 608 may further include storing the query in the fallback logs. In a more elaborative way, if the response generated in step 606 falls into any of the categories mentioned above (i.e., incorrect, ambiguous, or insufficient), the query is considered a fallback state. In this step, the query is logged and stored in the fallback logs. The fallback logs act as a record of user queries that the virtual agent is not able to understand or respond adequately.

Further, the method 600, at step 610 may further include mining the logs to obtain the plurality of fallback utterances and the method 600 terminates at 612. The logs are examined to identify the queries that resulted in fallback situations. These queries form the plurality of fallback utterances, representing the set of user inputs that the virtual agent struggled to understand or respond to accurately.

The mining process may include various techniques, such as natural language processing (NLP), data analysis, or machine learning algorithms, to extract and separate the fallback utterances from the rest of the logs. These utterances are then used for further analysis, classification, clustering, and generating suggestions for new training phrases and intent recommendations, as described in earlier steps of the present disclosure. Here are some techniques commonly employed in the mining process:
Natural Language Processing (NLP): NLP techniques are used to process and analyze the text data present in the fallback logs. These techniques include tasks such as tokenization, part-of-speech tagging, named entity recognition, sentiment analysis, and topic modeling. NLP helps extract linguistic features, understand the context, and derive meaningful information from the user queries.
Text Mining: Text mining techniques focus on extracting useful information from unstructured text data. It involves methods such as text categorization, information extraction, text summarization, and text clustering. Text mining helps to identify key topics, common themes, or recurring patterns within the fallback utterances.
Machine Learning (ML) Algorithms: ML algorithms may be employed to analyze and classify the fallback utterances. Techniques such as supervised learning (e.g., decision trees, support vector machines, neural networks), unsupervised learning (e.g., clustering, dimensionality reduction), or semi-supervised learning can be applied to identify patterns, group similar utterances, or categorize the fallback scenarios.
Topic Modeling: Topic modeling techniques, such as Latent Dirichlet Allocation (LDA) or Non-Negative Matrix Factorization (NMF), can be employed to discover latent topics or themes within the fallback utterances. This allows for the identification of underlying concepts or intents that may not be explicitly labeled.
Sentiment Analysis: Sentiment analysis techniques may be used to determine the sentiment expressed in the fallback utterances. This helps in understanding the user's emotions, satisfaction levels, or frustrations with the virtual agent's responses. Sentiment analysis may provide valuable insights for improving the system's understanding and addressing user concerns.
Data Visualization: Data visualization techniques, such as word clouds, bar charts, scatter plots, or heatmaps, may be employed to visually represent the patterns, distributions, or relationships discovered within the fallback logs. Visualization helps in interpreting the mined data, identifying outliers, or gaining a holistic view of the user queries.

In some example embodiments, a computer programmable product may be provided. The computer programmable product may comprise at least one non-transitory computer-readable storage medium having stored thereon computer-executable program code instructions that when executed by a computer, cause the computer to execute the method 600.

In an example embodiment, an apparatus for performing the method 600 of FIG. 6 above may comprise a processor (e.g., the processor 202) configured to perform some or each of the operations of the method 600. The processor may, for example, be configured to perform the operations (602-612) by performing hardware implemented logical functions, executing stored instructions, or executing algorithms for performing each of the operations. Alternatively, the apparatus may comprise means for performing each of the operations described above. In this regard, according to an example embodiment, examples of means for performing operations (602-612) may comprise, for example, the processor 202 which may be implemented in the system 200 and/or a device or circuit for executing instructions or executing an algorithm for processing information as described above.

FIG. 7 illustrates a method 700 for generating labels for new intent, in accordance with an example embodiment. It will be understood that each block of the flow diagram of the method 700 may be implemented by various means, such as hardware, firmware, processor, circuitry, and/or other communication devices associated with execution of software including one or more computer program instructions. For example, one or more of the procedures described above may be embodied by computer program instructions. In this regard, the computer program instructions which embody the procedures described above may be stored by a memory 204 of the system 200, employing an embodiment of the present disclosure and executed by a processor 202. As will be appreciated, any such computer program instructions may be loaded onto a computer or other programmable apparatus (for example, hardware) to produce a machine, such that the resulting computer or other programmable apparatus implements the functions specified in the flow diagram blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flow diagram blocks.

Accordingly, blocks of the flow diagram support combinations of means for performing the specified functions and combinations of operations for performing the specified functions for performing the specified functions. It will also be understood that one or more blocks of the flow diagram, and combinations of blocks in the flow diagram, may be implemented by special purpose hardware-based computer systems which perform the specified functions, or combinations of special purpose hardware and computer instructions.

The method 700 illustrated by the flow diagram of FIG. 7 for generating labels for new intent starts at step 702. The method 700 may include, at step 704, obtaining a plurality of fallback utterances. These utterances represent user queries or inputs that resulted in fallback scenarios, such as incorrect, ambiguous, or insufficient responses from the virtual agent. These fallback utterances act as the data for further analysis and intent categorization.

The method 700, at step 706, may include classifying the plurality of fallback utterances into one or more of existing intent categories, via a classification model. The classification model is trained on labeled data, where each utterance is associated with a specific intent category. By applying the classification model to the fallback utterances, the system attempts to assign them to the existing intent categories that best match their content and purpose. Here is an explanation of how the classification model typically works to perform this task:
Training the Classification Model: The classification model is trained on a labeled dataset, which consists of examples where each utterance is associated with a specific intent category. The labeled dataset serves as the training data for the model. During training, the model learns the patterns, features, and characteristics that differentiate one intent category from another.
Feature Extraction: Before applying the classification model, relevant features need to be extracted from the fallback utterances. These features may include textual characteristics such as keywords, n-grams (sequences of words), syntactic structures, or semantic representations. Feature extraction represent the utterances in a format that the model can understand and use for classification.
Applying the Classification Model: Once the features are extracted, the classification model is applied to the fallback utterances. The model uses the learned patterns from the training data to classify each utterance into one or more existing intent categories. This process involves feeding the extracted features into the model and obtaining predictions or probabilities for each intent category.
Assigning Intent Categories: Based on the predictions or probabilities generated by the classification model, each fallback utterance is assigned to the most suitable intent category. The model assigns the intent category that it believes best represents the content and purpose of the utterance. In cases where multiple intent categories are possible, the model may assign probabilities to indicate the confidence level for each category.
Evaluation and Adjustment: The performance of the classification model is evaluated using evaluation metrics such as accuracy, precision, recall, or F1 score. If the model's performance is not satisfactory, it may require adjustments, such as fine-tuning the model's parameters, retraining with more labeled data, or exploring different classification algorithms or architectures.
Handling Unclassified Utterances: In some cases, the classification model may not be able to confidently assign an intent category to certain fallback utterances. These unclassified utterances are typically handled in subsequent steps, such as clustering, to further analyze and understand their patterns or themes.

The method 700 may include, at step 708, clustering the one or more utterances into one or more groups upon unsuccessful classification of one or more utterances of the plurality of fallback utterances, based on similarities among the one or more utterances, via a clustering model. clustering model is used to perform this task. The clustering model identifies groups or clusters of utterances that exhibit similar characteristics, patterns, or themes. This process aims to group together fallback utterances that share common features or intents but could not be assigned to existing intent categories through classification.

There are various clustering algorithms available, such as K-means, hierarchical clustering, DBSCAN (Density-Based Spatial Clustering of Applications with Noise), or spectral clustering. The choice of algorithm depends on the nature of the data and the desired clustering outcome. Each algorithm has its own way of defining clusters based on different criteria, such as distance, density, or connectivity. The clustering model is applied to the unclassified fallback utterances. The clustering model analyzes the extracted features and groups similar utterances together into clusters. The similarity between utterances is typically determined based on distance metrics, such as Euclidean distance or cosine similarity, which measure the similarity in feature space.

The method 700 may further include, at step 710, generating labels for the one or more groups to determine names of new intent categories associated with the one or more utterances. These labels act as names or identifiers for the new intent categories associated with the clustered utterances. The labels are generated to reflect the underlying theme or purpose shared by the utterances within each cluster.

The step 710 may include a sub-step 712 for generating the labels. In an embodiment, at step 712 generating the labels comprises assigning generic names to the one or more groups, and the method 700 terminates at step 714. In the sub-step 712, a process is followed to assign generic names to the clusters. The generic names provide a high-level representation of the intent or concept encompassed by the cluster, without delving into specific details. These generic labels capture the common theme or purpose of the clustered utterances.

Intent name generation algorithms employ various techniques to generate meaningful labels for the one or more groups of clusters. Some common approaches include:

Keyword Extraction: Extracting important keywords or phrases from the utterances within each cluster can provide descriptive labels that capture the central theme. This may be done using techniques like TF-IDF (Term Frequency-Inverse Document Frequency), TextRank, or other keyword extraction algorithms.

Topic Modeling: Applying topic modeling algorithms, such as Latent Dirichlet Allocation (LDA) or Non-Negative Matrix Factorization (NMF), to the utterances within each cluster may help identify dominant topics or themes. The generated topics may serve as labels for the clusters.

Semantic Analysis: Leveraging semantic analysis techniques, such as word embeddings or contextualized word representations (e.g., BERT) may capture the semantic meaning of the utterances. By analyzing the semantic relationships and similarities among the clustered utterances, labels may be generated based on the overarching intent or concept.

Rule-based Labeling: Establishing a set of predefined rules or heuristics may be useful for assigning labels based on specific patterns or characteristics observed within the clusters. These rules may be based on linguistic patterns, frequently occurring terms, or other domain-specific criteria.

By employing intent name generation algorithms, the system generates labels for the clusters obtained from the clustering step. These labels represent the names or identifiers associated with the new intent categories detected from the fallback utterances. The generated labels may then be used to further enhance the virtual agent understanding and training phrases, improving its performance and accuracy in responding to user interactions.

In some example embodiments, a computer programmable product may be provided. The computer programmable product may comprise at least one non-transitory computer-readable storage medium having stored thereon computer-executable program code instructions that when executed by a computer, cause the computer to execute the method 700.

In an example embodiment, an apparatus for performing the method 700 of FIG. 7 above may comprise a processor (e.g., the processor 202) configured to perform some or each of the operations of the method 700. The processor may, for example, be configured to perform the operations (702-710) by performing hardware implemented logical functions, executing stored instructions, or executing algorithms for performing each of the operations. Alternatively, the apparatus may comprise means for performing each of the operations described above. In this regard, according to an example embodiment, examples of means for performing operations (702-710) may comprise, for example, the processor 202 which may be implemented in the system 200 and/or a device or circuit for executing instructions or executing an algorithm for processing information as described above.

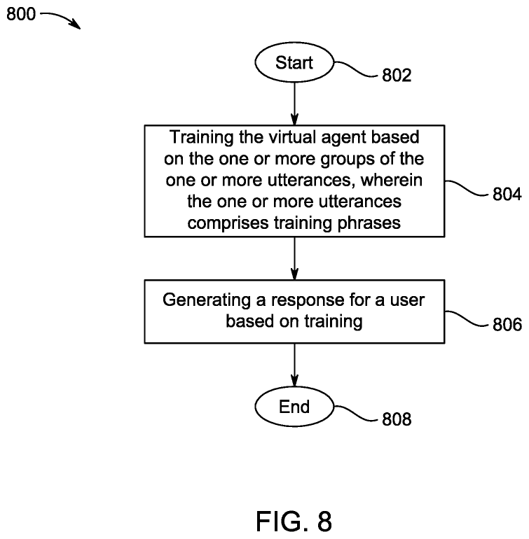

FIG. 8 illustrates a method 800 for generating a response based on training a virtual agent, in accordance with an example embodiment. It will be understood that each block of the flow diagram of the method 800 may be implemented by various means, such as hardware, firmware, processor, circuitry, and/or other communication devices associated with execution of software including one or more computer program instructions. For example, one or more of the procedures described above may be embodied by computer program instructions. In this regard, the computer program instructions which embody the procedures described above may be stored by a memory 204 of the system 200, employing an embodiment of the present disclosure and executed by a processor 202. As will be appreciated, any such computer program instructions may be loaded onto a computer or other programmable apparatus (for example, hardware) to produce a machine, such that the resulting computer or other programmable apparatus implements the functions specified in the flow diagram blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flow diagram blocks.

Accordingly, blocks of the flow diagram support combinations of means for performing the specified functions and combinations of operations for performing the specified functions for performing the specified functions. It will also be understood that one or more blocks of the flow diagram, and combinations of blocks in the flow diagram, may be implemented by special purpose hardware-based computer systems which perform the specified functions, or combinations of special purpose hardware and computer instructions.

The method 800 illustrated by the flow diagram of FIG. 8 for generating a response based on training a virtual agent may start at step 802 and at step 804, the method 800 may include training the virtual agent based on the one or more groups of the one or more utterances, wherein the one or more utterances comprises training phrases. By training the virtual agent using the groups of utterances obtained from the clustering process, the method 800 enables the virtual agent to learn from the identified intent categories and associated training phrases. This training enhances the virtual agent ability to accurately understand user queries and generate relevant responses, improving the overall user experience and interaction with the virtual agent.

Here is an explanation of how training is typically done by considering these groups of utterances:
Data Preparation: The one or more groups of utterances obtained from the previous steps are used as training data for the virtual agent. This data is typically preprocessed and formatted to create a suitable training dataset. Preprocessing steps may include cleaning the text, tokenization (splitting into individual words or tokens), removing stop words, and performing any other necessary text transformations.
Intent Labeling: Each utterance in the training dataset is associated with an intent label. The intent label represents the desired action or meaning of the user query. In this case, the one or more groups of utterances have been assigned labels or names during the intent name generation step. These labels are used to categorize the utterances based on their intended meaning.
Feature Extraction: Features are extracted from the training utterances to represent them in a numerical format that can be understood by the training algorithm. This process may involve techniques such as bag-of-words representation, word embeddings (e.g., Word2Vec, GloVe), or contextualized embeddings (e.g., BERT). The extracted features capture the important information and context of the training phrases.
Model Training: With the training data prepared and the features extracted, the virtual agent training process begins. Machine learning algorithms, such as neural networks, decision trees, or support vector machines, are commonly used for training virtual agents. The algorithm learns to map the input features (training phrases) to their corresponding intent labels based on the patterns and relationships present in the data.
Optimization and Iteration: During training, the model undergoes an optimization process to adjust its internal parameters and optimize its performance. This is typically done by minimizing a loss function that quantifies the discrepancy between the predicted intent labels and the true intent labels of the training data. The optimization process aims to find the best parameters that minimize this discrepancy.
Evaluation and Performance Metrics: After the model is trained, it is evaluated using a separate validation or test dataset to assess its performance. Evaluation metrics such as accuracy, precision, recall, or F1 score can be used to measure the model's ability to correctly classify new user queries. If the performance is not satisfactory, the training process may be repeated or adjusted by modifying the model architecture, hyperparameters, or training data.

The method 800, at step 806 may further include generating a response for a user based on training and the method 800 further terminates at step 808. Once the virtual agent is trained, it may generate responses for user queries based on the acquired knowledge. When a user submits a query, the virtual agent uses its trained model to understand the query's intent and context. It then generates an appropriate response that aligns with the intent and provides relevant information or assistance to the user. The training process allows the virtual agent to understand and classify user queries accurately, providing appropriate and relevant responses.

In some example embodiments, a computer programmable product may be provided. The computer programmable product may comprise at least one non-transitory computer-readable storage medium having stored thereon computer-executable program code instructions that when executed by a computer, cause the computer to execute the method 800.

In an example embodiment, an apparatus for performing the method 800 of FIG. 8 above may comprise a processor (e.g., the processor 202) configured to perform some or each of the operations of the method 800. The processor may, for example, be configured to perform the operations (802-808) by performing hardware implemented logical functions, executing stored instructions, or executing algorithms for performing each of the operations. Alternatively, the apparatus may comprise means for performing each of the operations described above. In this regard, according to an example embodiment, examples of means for performing operations (802-808) may comprise, for example, the processor 202 which may be implemented in the system 200 and/or a device or circuit for executing instructions or executing an algorithm for processing information as described above.

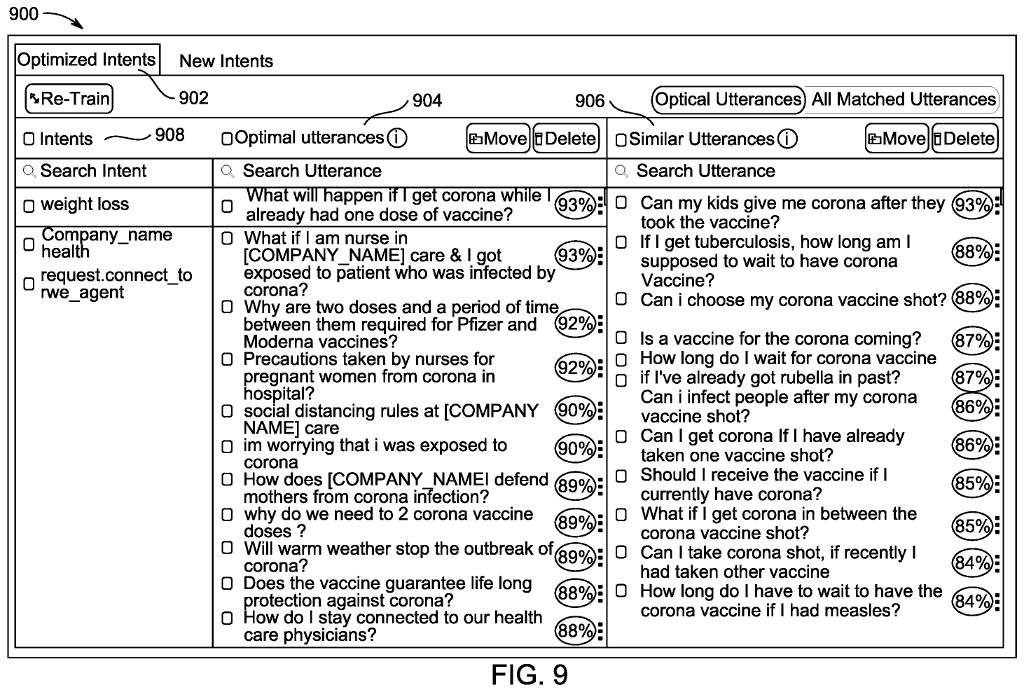

FIG. 9 illustrates an exemplary GUI 900 depicting a classified utterances view, in accordance with an example embodiment. This view provides a visual representation of the classified utterances obtained from the classification step in the intent recognition process. The interface may offer search and filter functionalities to help narrow down and focus on specific utterances or intent categories. In an embodiment, there are various data structures that may be used depending on the specific requirements and programming language/framework used. Some examples of data structures applicable for implementing GUI 900 could include:
Lists/Arrays: Lists or arrays may be used to store and manage the various options and elements within the GUI. For example, the list of optimal utterances, similar utterances, and intent options may be stored as arrays or lists.
Dictionaries/Maps: Dictionaries or maps may be used to store key-value pairs for efficient retrieval and management of data. In the context of GUI 900, dictionaries may be used to map the optimal utterances, similar utterances, and intent options to their corresponding scores or other relevant information.
Tree Structures: Tree structures, such as hierarchical data structures, may be used to represent the organization and relationships between different components of the GUI. For example, if the GUI 900 has nested menus or sub-options, a tree structure can be employed to represent these relationships.
Graph Structures: Graph structures may be used to represent connections and dependencies between different components in the GUI 900. For instance, if there are relationships or associations between different intents or utterances, a graph structure may capture these connections.
Object-Oriented Models: Object-oriented models may be used to represent the various components and their attributes within the GUI. This approach involves creating classes or objects that encapsulate the data and behavior of the GUI elements, allowing for easier management and manipulation of the data.

In an embodiment, the user selects “Optimized Intent” window 902 from the GUI 900. This action opens a new window that presents an “Optimized Utterances” 904, a “Similar Utterances” 906, and an “Intents” 908 associated with the selected utterances.

Within the “Optimized Intent” window 902, the user can find the “Optimal Utterances” option 904. This option displays a list of carefully selected utterances that have been classified as relevant and representative of the associated intent. Each utterance is accompanied by a score indicating its relevance or confidence level. Examples of optimized utterances mentioned in the description:
“What will happen if I get corona while I already had one dose of vaccine?” (Score 93%)
“What if I am a nurse in [COMPANY NAME] care & I got exposed to a patient who was infected by corona?” (Score 93%)
“Why are two doses and a period of time between them required for Pfizer and Moderna vaccines?” (Score 92%) . . . .

The “Similar Utterances” option 906 provides a list of utterances that are similar to the optimized utterances. These utterances share common themes or topics and can provide additional context or variations related to the associated intent. Examples of similar utterances mentioned in the description:
“Can my kids give me corona after they took the vaccine?” (Score 93%)
“I get tuberculosis, how long am I supposed to wait to have corona Vaccine?” (Score 88%)
“Can I choose my corona vaccine shot?” (Score 88%)
“Is a vaccine for the corona coming?” (Score 87%) . . . .

The “Intents” option 908 displays a list of intents associated with the optimized and similar utterances. These intents represent the identified themes or categories to which the utterances belong. Examples of intents mentioned in the description:
“Weight Loss”
“[COMPANY NAME] Health” . . . .

Thus, the GUI 900 allows users to view and analyze classified utterances, explore optimized and similar utterances, and identify the intents associated with them. This helps in understanding user queries, improving the virtual agent training, and facilitating effective communication and responses to user queries.

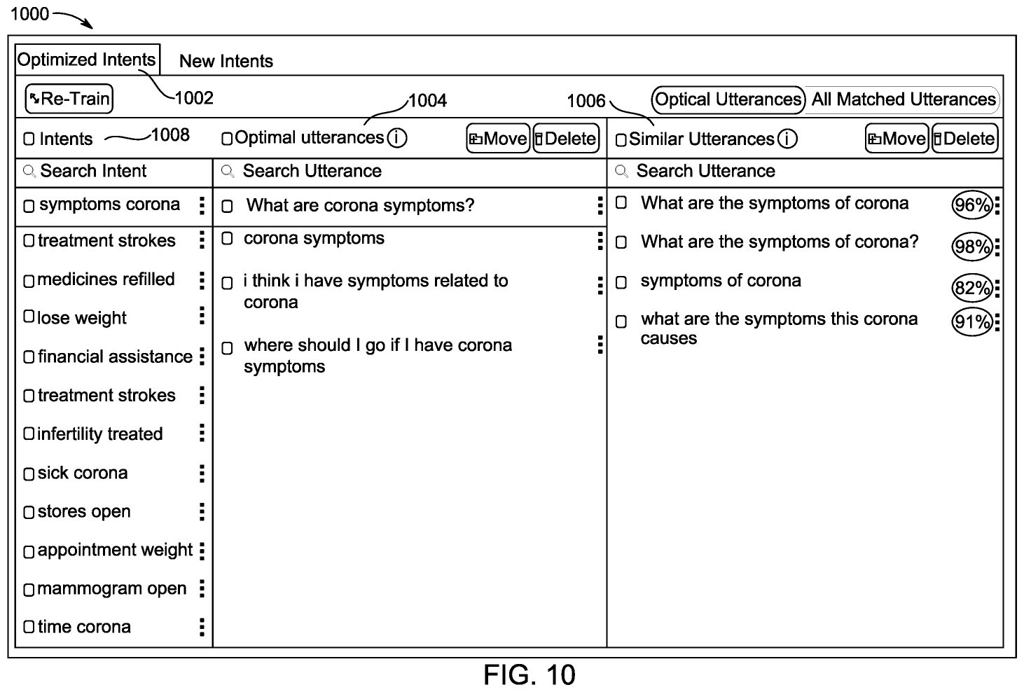

FIG. 10 illustrates an exemplary GUI 1000 depicting a newly identified utterances view, in accordance with an example embodiment. It offers options and windows to explore and analyze these utterances, helping identify new intents. In an embodiment, there are various data structures that may be used here for implanting the GUI 1000. Some examples of data structures that could be applicable for implementing GUI 1000 are:
List or Array: The optimal utterances 1004 and similar utterances 1006 can be stored as lists or arrays, where each element represents an utterance. The intents 1008 can also be stored as a list or array, where each element represents an identified intent.
Dictionary or Map: To associate additional information with each utterance or intent, a dictionary or map data structure can be used. For example, the optimal utterances 1004 may be stored as a dictionary, where the utterance is the key, and the associated information (such as scores or metadata) is the value. Similarly, the intents 1008 may be stored as a dictionary, with the intent name as the key and any relevant details as the value.
Object or Class: Instead of using simple data structures, an object-oriented approach can be taken by defining custom classes or objects to represent utterances and intents. Each utterance object can contain attributes like the actual utterance text, scores, and other relevant properties. Similarly, each intent object can have attributes such as the intent name and any associated information.
Tree or Graph: If there is a hierarchical relationship between intents or utterances, a tree or graph data structure can be useful. This may represent a taxonomy or hierarchy of intents, with parent-child relationships, allowing for efficient navigation and organization of the data.

In an embodiment, the user opens the “New Intents” window 1002 from the GUI 1000. This action opens a new window specifically designed for managing the newly identified utterances.

Within the “New Intents” window 1002, the user can find the “Optimal Utterances” option 1004. This option displays a list of carefully selected utterances that have been identified as relevant and representative of the newly identified intents. Examples of optimal utterances mentioned in the description:
“What are corona symptoms?”
“Corona symptoms.”
“I think I have symptoms related to corona.”
“Where should I go if I have corona symptoms?”

The “Similar Utterances” option 1006 provides a list of utterances that are similar to the optimal utterances. These utterances share similar themes or topics and may provide additional context or variations related to the newly identified intents. Examples of similar utterances mentioned in the description:
“What are the symptoms of corona” (Score 96%)
“What are the symptoms of corona?” (Score 98%)
“Symptoms of corona” (Score 82%)
“What are the symptoms this corona causes?” (Score 91%)

The “Intents” option 1008 displays a list of intents associated with the optimal and similar utterances. These intents represent the newly identified themes or categories to which the utterances belong. Examples of intents mentioned in the description:
“Symptom Corona”
“Treatment Strokes”

In particular, the GUI 1000 allows users to view and analyze newly identified utterances, explore optimal and similar utterances, and identify the intents associated with them. This helps in recognizing emerging patterns or themes in user queries, facilitating the creation of new intent categories, and improving the virtual agent training to handle these specific topics.

As will be appreciated by those skilled in the art, the techniques described in the various embodiments discussed above are not routine, or conventional, or well understood in the art. The present disclosure addresses the problem of fallback logs to suggest new training phrases for existing intents and recommend new intents based on clusters of fallback utterances. The primary goal of the present invention is to automate the identification of new intents and training phrase suggestions, minimizing the manual effort involved.

The techniques discussed above provide advantages like, it automates entirely manual process and reduces considerable manual hours spent by developers on manually identifying new intents and possible training phrases of existing intents. Further, the techniques provide significant reduction in manual effort for identifying new intents and training phrases, integration into existing processing pipelines, and enhancing overall system efficiency.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

It is to be understood that the above description is intended to be illustrative, and not restrictive. For example, the above-discussed embodiments may be used in combination with each other. Many other embodiments will be apparent to those of skill in the art upon reviewing the above description.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

The benefits and advantages which may be provided by the present invention have been described above with regard to specific embodiments. These benefits and advantages, and any elements or limitations that may cause them to occur or to become more pronounced are not to be construed as critical, required, or essential features of any or all of the embodiments.

While the present invention has been described with reference to particular embodiments, it should be understood that the embodiments are illustrative and that the scope of the invention is not limited to these embodiments. Many variations, modifications, additions, and improvements to the embodiments described above are possible. It is contemplated that these variations, modifications, additions, and improvements fall within the scope of the invention.

What is claimed is:

1. A computer-implemented method for training a virtual agent through fallback analysis comprising:
obtaining a plurality of fallback utterances;
classifying the plurality of fallback utterances into one or more of existing intent categories, via a Machine Learning (ML) model;
upon unsuccessful classification of one or more utterances of the plurality of fallback utterances, clustering the one or more utterances into one or more groups based on similarities among the one or more utterances, via the ML model; and
generating labels for the one or more groups to determine names of new intent categories associated with the one or more utterances.

2. The computer-implemented method of claim 1, further comprising training the virtual agent based on the one or more groups of the one or more utterances, wherein the one or more utterances comprises training phrases.

3. The computer-implemented method of claim 1, wherein fallback logs comprise the plurality of fallback utterances.

4. The computer-implemented method of claim 1, wherein the plurality of fallback utterances corresponds to at least one of incorrect responses, ambiguous responses, or insufficient responses generated by the virtual agent for queries.

5. The computer-implemented method of claim 1, further comprising:
receiving a query from a user;
generating a response for the query, wherein the response is one of an incorrect response, an ambiguous response, or an insufficient response;
storing the query in the fallback logs; and
mining the logs to obtain the plurality of fallback utterances.

6. The computer-implemented method of claim 1, wherein the ML model is a classification model.

7. The computer-implemented method of claim 6, wherein the classification model comprises at least one of a logistic regression model, a decision tree, a random forest model, a Support Vector Machine (SVM), or an automated machine learning (AutoML) model.

8. The computer-implemented method of claim 1, wherein the ML model is a clustering model.

9. The computer-implemented method of claim 7, wherein the clustering model uses at least one of a K-means clustering algorithm, a hierarchical clustering algorithm, a density-based spatial clustering algorithm, a gaussian mixture model, or hybrid ensemble models.

10. The computer-implemented method of claim 1, wherein generating the labels comprises assigning generic names to the one or more groups.

11. A computer system for training a virtual agent through fallback analysis comprising, the computer system comprising: one or more computer processors, one or more computer readable memories, one or more computer readable storage devices, and program instructions stored on the one or more computer readable storage devices for execution by the one or more computer processors via the one or more computer readable memories, the program instructions comprising:
obtaining a plurality of fallback utterances;
classifying the plurality of fallback utterances into one or more of existing intent categories, via a Machine Learning (ML) model;
upon unsuccessful classification of one or more utterances of the plurality of fallback utterances, clustering the one or more utterances into one or more groups based on similarities among the one or more utterances, via the ML model; and
generating labels for the one or more groups to determine names of new intent categories associated with the one or more utterances.

12. The system of claim 11, further comprising training the virtual agent based on the one or more groups of the one or more utterances, wherein the one or more utterances comprises training phrases.

13. The system of claim 11, wherein fallback logs comprise the plurality of fallback utterances, and wherein the plurality of fallback utterances corresponds to at least one of incorrect responses, ambiguous responses, or insufficient responses generated by the virtual agent for queries.

14. The system of claim 11, further comprising:
receiving a query from a user;
generating a response for the query, wherein the response is one of an incorrect response, an ambiguous response, or an insufficient response;
storing the query in the fallback logs; and
mining the logs to obtain the plurality of fallback utterances.

15. The system of claim 11, wherein the ML model is a classification model.

16. The system of claim 15, wherein the classification model comprises at least one of a logistic regression model, a decision tree, a random forest model, a Support Vector Machine (SVM), or an automated machine learning (AutoML) model.

17. The system of claim 11, wherein the ML model is a clustering model.

18. The system of claim 17, wherein the clustering model uses at least one of a K-means clustering algorithm, a hierarchical clustering algorithm, a density-based spatial clustering algorithm, a gaussian mixture model, or hybrid ensemble models.

19. The system of claim 11, wherein generating the labels comprises assigning generic names to the one or more groups.

20. A non-transitory computer-readable storage medium having stored thereon computer executable instruction which when executed by one or more processors, cause the one or more processors to carry out operations for training a virtual agent through fallback analysis, the operations comprising perform the operations comprising:
obtaining a plurality of fallback utterances;
classifying the plurality of fallback utterances into one or more of existing intent categories, via a Machine Learning (ML) model;
upon unsuccessful classification of one or more utterances of the plurality of fallback utterances, clustering the one or more utterances into one or more groups based on similarities among the one or more utterances, via the ML model; and
generating labels for the one or more groups to determine names of new intent categories associated with the one or more utterances.
